(19) United States
(12) Patent Application Publication
(10) Pub. No.: US 2009/0089692 A1
(43) Pub. Date: Apr. 2, 2009

(54) Method And System For Presenting Information Relating To A Plurality Of Applications Using A Three Dimensional Object

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/864,014

(22) Filed: Sep. 28, 2007

(51) Int. Cl. G06F 3/048

(52) U.S. Cl. 715/764

(57) ABSTRACT

Presenting information relating to a plurality of applications includes presenting full-screen on a display of an electronic device a first side widget that includes a first presentation space, and presenting on the display, in response to receiving a first input, a three-dimensional polyhedron having a plurality of sides including a first side corresponding to the first side widget and a selectable second side corresponding to a second side widget. A second input associated with a selection of the selectable second side of the polyhedron is received, and in response, the second side widget that includes a second presentation space is presented full-screen on the display such that no other side of the polyhedron, including the first side, is visible. When the first side widget is presented full-screen on the display, no other side of the polyhedron, including the second side, is visible.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Electronic devices offer a plethora of services, capabilities and user applications. In most cases, a user of such a device can select a service, capability or application by navigating through a graphical user interface (GUI) displayed on a screen or display associated with the electronic device. Typically, the GUI adheres to a hierarchical structure. That is, the various services, capabilities and applications are nested under specific and general categories or headings.

For example, a camera phone can be used to make and receive telephone calls and to capture digital images. The GUI will typically organize phone applications and phone services in a hierarchical format under a general category of phone features, while camera applications and camera services will be organized in a hierarchical format under a general category of camera features. Typically, applications and services are represented as “widgets.” In general, a widget is an element of the GUI that displays information or provides a specific way for the user to interact with the operating system and application. Widgets include icons, pull-down menus, buttons, selection boxes, progress indicators, on-off checkmarks, scroll bars, windows, window edges, toggle buttons, forms, and many other devices for displaying information and for inviting, accepting, and responding to user actions.

Thus, if the user wishes to transmit an image stored in the camera phone over the Internet, the user might interact, e.g., select, a camera widget corresponding to camera applications and services, which would then cause several camera application and service widgets to be displayed to the user. One of the camera application and service widgets can correspond to Internet services, which when selected, can cause to be displayed a set of Internet application and service widgets. The user can then select an Internet application or service widget corresponding to the desired function and repeat the process above until the image is sent.

For some users, navigating through a hierarchical GUI is very difficult. These users might not be familiar with such hierarchical structures and/or how and where certain applications or services might be located logically. Moreover, during navigation between various levels of the hierarchy, the user might easily lose sense of where he or she is within the hierarchy. This can occur frequently and thus be particularly frustrating for users that are not spatially oriented in their thinking.

As a result, in many instances, when the user has difficulty navigating through the layers of a hierarchical GUI, the user can be uncomfortable using his or her device for more than a few well-known tasks. Accordingly, the user is not able to enjoy the full capabilities of the device.

In recognition of this issue, some devices implement non-hierarchical GUIs. For example, instead of nesting applications and services under general categories, such non-hierarchical GUIs display the applications and services on different sides of a three dimensional (3-D) object. This GUI is feasible for a device with a large screen, e.g., a desktop and monitor system, where the display is large enough to present multiple sides of the 3-D object so that the user can see and interact with multiples sides of the 3-D object. Nevertheless, implementing the same GUI in a small screen device, e.g., a PDA or mobile phone, where the 3-D object must be small enough to fit in the display area, is not feasible because the user cannot easily interact with the 3-D object due to its size.

Accordingly, there exists a need for methods, systems, and computer program products for presenting information relating to a plurality of applications in an electronic device.

### SUMMARY

Methods and systems are described for presenting information relating to a plurality of applications. One method includes presenting full-screen on a display of an electronic device a first side widget that includes a first presentation space, and presenting on the display, in response to receiving a first input, a three-dimensional polyhedron having a plurality of sides including a first side corresponding to the first side widget and a selectable second side corresponding to a second side widget. The method further includes receiving a second input associated with a selection of the selectable second side of the polyhedron, and in response, presenting full-screen on the display the second side widget that includes a second presentation space, wherein when the second side widget is presented full-screen on the display, no other side of the polyhedron, including the first side, is visible, and vice versa.

In another aspect of the subject matter disclosed herein, a system for presenting information relating to a plurality of applications includes means for presenting full-screen on a display of an electronic device a first side widget that includes a first presentation space, and means for presenting on the display, in response to receiving a first input, a three-dimensional polyhedron having a plurality of sides including a first side corresponding to the first side widget and a selectable second side corresponding to a second side widget. The system further includes means for receiving a second input associated with a selection of the selectable second side of the polyhedron, and means for presenting full-screen on the display the second side widget that includes a second presentation space, where no other side of the polyhedron, including the first side, is visible when the second side widget is presented full-screen on the display and vice versa.

In another aspect of the subject matter disclosed herein, a system for presenting information relating to a plurality of applications available in an electronic device is described. The system includes a display associated with an electronic device, a graphical user interface manager component coupled to the display and configured for receiving inputs, and a display manager component coupled to the graphical user interface manager. The display manager component is configured for presenting full-screen on the display a first side widget that includes a first presentation space. In response to the graphical user interface manager component receiving a first input, the display manager component is configured for presenting on the display a three dimensional representation of a polyhedron having a plurality of sides including a first side corresponding to the first side widget and a selectable second side corresponding to a second side widget. In response to the graphical user interface manager component receiving a second input associated with a selection of the selectable second side of the polyhedron, the display manager component is configured for presenting full-screen on the display the second side widget that includes a second presentation space, where no other side of the polyhedron, including the first side, is visible when the second side widget is presented full-screen on the display and vice versa.

In another aspect of the subject matter disclosed herein, a computer readable medium containing a computer program, executable by a machine, for presenting information relating to a plurality of applications includes instructions for presenting full-screen on a display of an electronic device a first side widget that includes a first presentation space, and presenting on the display, in response to receiving a first input, a three-dimensional polyhedron having a plurality of sides including a first side corresponding to the first side widget and a selectable second side corresponding to a second side widget. The computer readable medium includes further instructions for receiving a second input associated with a selection of the selectable second side of the polyhedron, and in response, presenting full-screen on the display the second side widget that includes a second presentation space, no other side of the polyhedron, including the first side, is visible when the second side widget is presented full-screen on the display and vice versa.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a client device according to an exemplary embodiment;

FIG. 2 is a block diagram illustrating a display manager component according to an exemplary embodiment;

FIG. 3 is a flowchart illustrating a method for presenting information relating to a plurality of applications according to an exemplary embodiment; and

FIGS. 4A-4E illustrate exemplary client devices including a display presenting sides of a 3-D polyhedron according to an exemplary embodiment.

### DETAILED DESCRIPTION

Methods, systems, and computer program products for presenting information relating to a plurality of applications in an electronic client device are disclosed. In this discussion, executable data objects and data components are described. Those skilled in the art understand that an executable data object includes identifiable executable entities such as functions, methods, and subroutines, and associated data entities, such as constants and variables. It is further understood that executable data objects and data components can be associated with multiple representations, known as instances, that are accessible by a processor. For ease of expression, the “instances” of executable data objects and data components will be referred to by the name of a corresponding executable object and/or data component of which each is an instance. The term “instance” is used for emphasis in some portions of this description. When the term “instance” is not used in association with a named component, it will be understood by those skilled in the art from the document context when an instance of a component is being referred to and when the component itself is being referred to.

According to one embodiment, a GUI of the client device presents information relating to the plurality of applications and capabilities on at least two sides of a 3-D polyhedron. As used in this description, a polyhedron is a three-dimensional shape that is made up of a finite number of polygonal sides or faces that are parts of planes. The sides meet in pairs along edges that are straight-line segments, and the edges meet in points called vertices. For example, a polyhedron can be a cube, a prism, and a pyramid.

In one embodiment, at least two sides of the 3-D polyhedron correspond to side widgets, each of which includes a presentation space. The presentation space can be used to present a widget associated with a user application or device capability. When one of the sides of the 3-D polyhedron is selected, the side widget corresponding to the selected side can be automatically presented full-screen on the display such that all other sides and corresponding side widgets are not seen. Because no other sides of the 3-D polyhedron are presented, the user can easily see and interact with the application widget and/or capability widget in the presentation space of the side widget, especially when the display screen is small. Accordingly, a spatially oriented GUI can be effectively implemented for a small screened handheld electronic device.

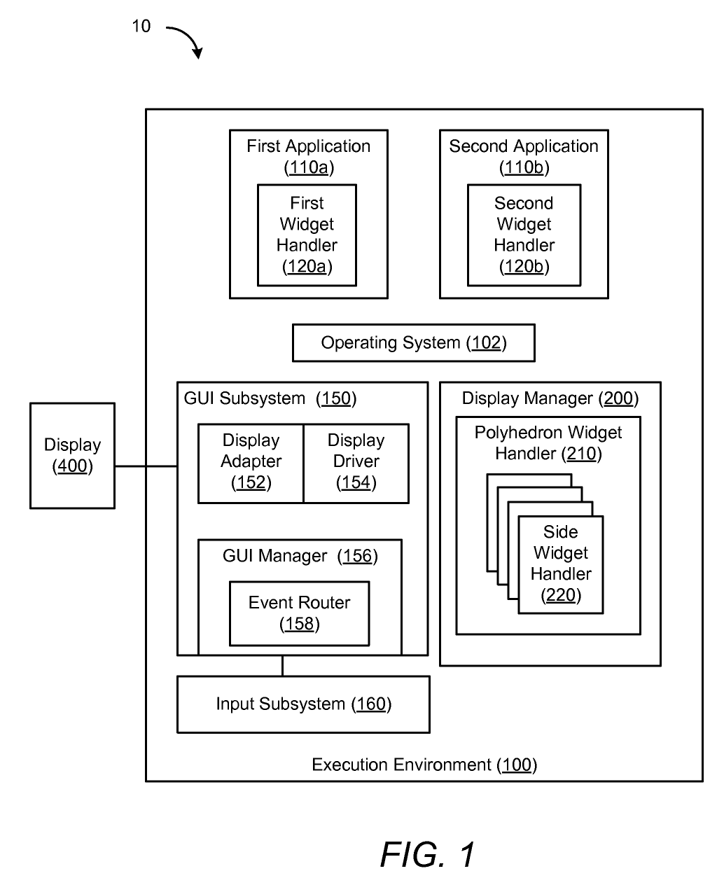

FIG. 1 is a block diagram illustrating an electronic client device according to one embodiment. The device 10 includes an execution environment 100 which provides a platform configured for loading and processing machine code objects including applications 110a, 110b, device drivers, shared machine code libraries, and other forms of data objects. For example, an exemplary execution environment 100 is configured to access a persistent data store (not shown) for storing a loadable representation of an application and/or other data objects. The exemplary execution environment 100 can also include a processor memory (not shown) such as a random access memory (RAM) for storing data objects such as an executable representation of an application. The processor memory can be accessible by a processor (not shown) configured to access instructions and data included in and/or otherwise associated with the executable data objects, e.g., applications 110a, 110b, for processing.

The execution environment 100 includes an operating system (OS) 102 for loading a representation of a data object from persistent storage into processor memory for processing by the processor. The operating system 102 typically interoperates with a number of subsystems of the execution environment 100 for controlling various hardware and software components.

For example, the execution environment 100 includes a GUI subsystem 150 for generating and presenting visual representations according to instructions from the applications 110a, 110b and/or other data objects. The GUI subsystem 150 can include a GUI manager 156 that receives instructions to draw a visual representation, and a display adapter 152 operatively coupled to a display 400. Typically, the GUI manager 156 directs the display adapter 152 to present the visual representation on the display 400. For example, the display adapter 152 can be operatively coupled to a display driver 154, and the GUI manager 156 can be operatively coupled to an interface provided by the display driver 154. Display buffers (not shown) can provide memory for storing the visual representation. During presentation, the GUI manager 156 can instruct the display driver 154 to provide the display buffers including the stored visual representation to the display adapter 152 for presentation on the display 400.

According to an exemplary embodiment, the execution environment 100 includes a display manager component 200 for presenting information relating to the plurality of applications. The display manger component 200, in one embodiment, is configured to provide a 3-D polyhedron widget handler instance 210 corresponding to a 3-D polyhedron to be presented on the display 400. In an exemplary embodiment, the 3-D polyhedron provides a presentation and navigation metaphor for a user of the device 10 and a user interface context for a developer of an application providing a user interface for display in the presentation space provided by the display manager 200.

The 3-D polyhedron widget handler 210 comprises or references instances of a plurality of side widget handlers 220. Each instance of the side widget handler 220, in one embodiment, is associated with a side of the 3-D polyhedron and is configured to generate the side widget corresponding to the associated side of the 3-D polyhedron. According to an exemplary embodiment, each instance of the side widget handler 220 is also configured for creating and managing the presentation space of the corresponding side widget for presenting widgets of one or more applications and/or other executable components operating in the execution environment 100.

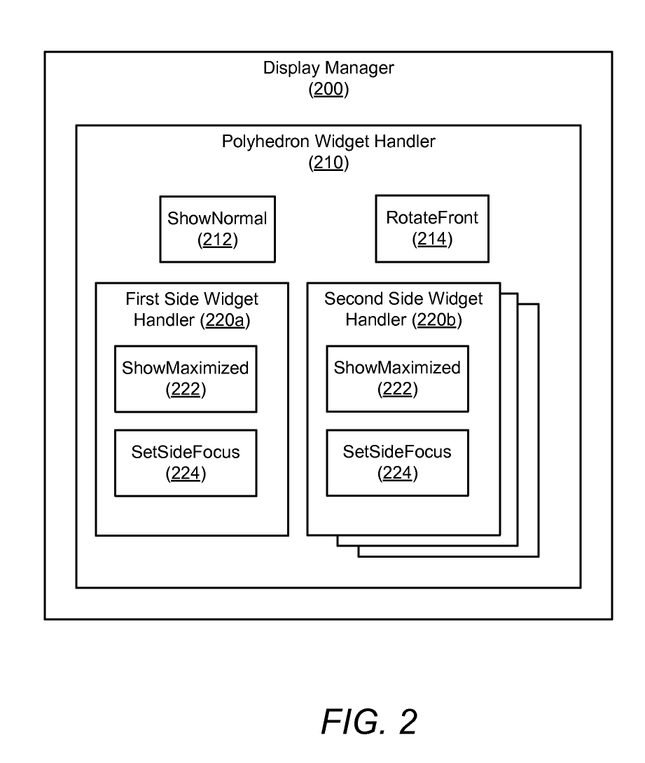

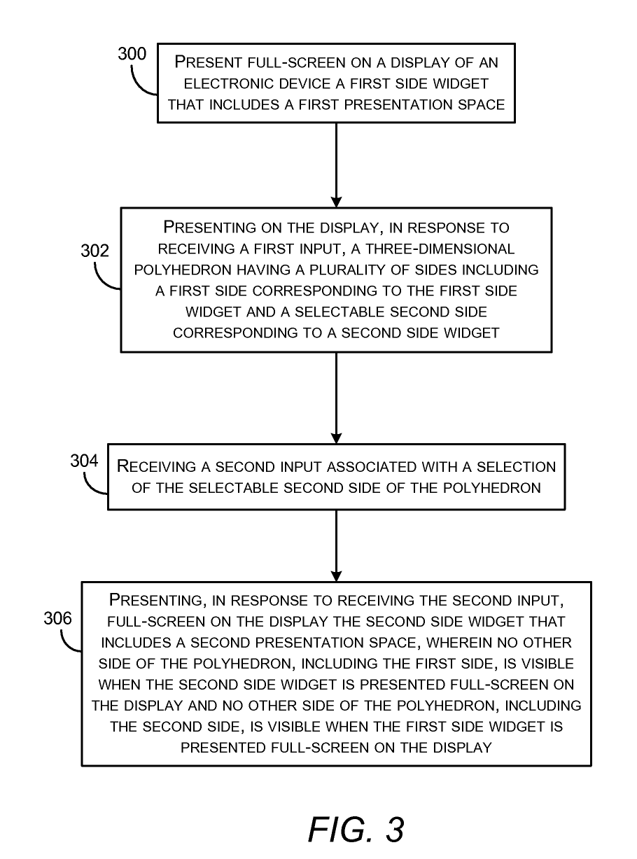

To describe the functionality of the display manager component 200, reference to FIG. 2 and FIG. 3 is made. FIG. 2 is block diagram illustrating the display manager component 200 in more detail according to an exemplary embodiment, and FIG. 3 is a flowchart illustrating an exemplary method for presenting information relating to a plurality of applications according to one embodiment. Referring FIG. 1, FIG. 2 and FIG. 3, the exemplary method begins when a first side widget of a 3-D polyhedron that includes a first presentation space is presented full-screen on a display 400 of the device 10 (block 300). According to an exemplary embodiment, the device 10 includes means for presenting full-screen on the display 400 of the device 10 the first side widget that includes the first presentation space. For example, a first side widget handler 220a (FIG. 2) in the display manager component 200 can be configured to perform this function.

In one embodiment, the first side widget handler 220a can instruct the GUI manager 156 to draw a visual representation of the first side widget on the display 400. The first side widget handler 220a can control various characteristics of the visual representation such as the font, color(s), and position of portions of the first side widget. Alternatively, or in addition, the operating system 102, the GUI manager 156, and/or another component of the execution environment 100 can be configured to manage a portion of the presentation characteristics of the first side widget.

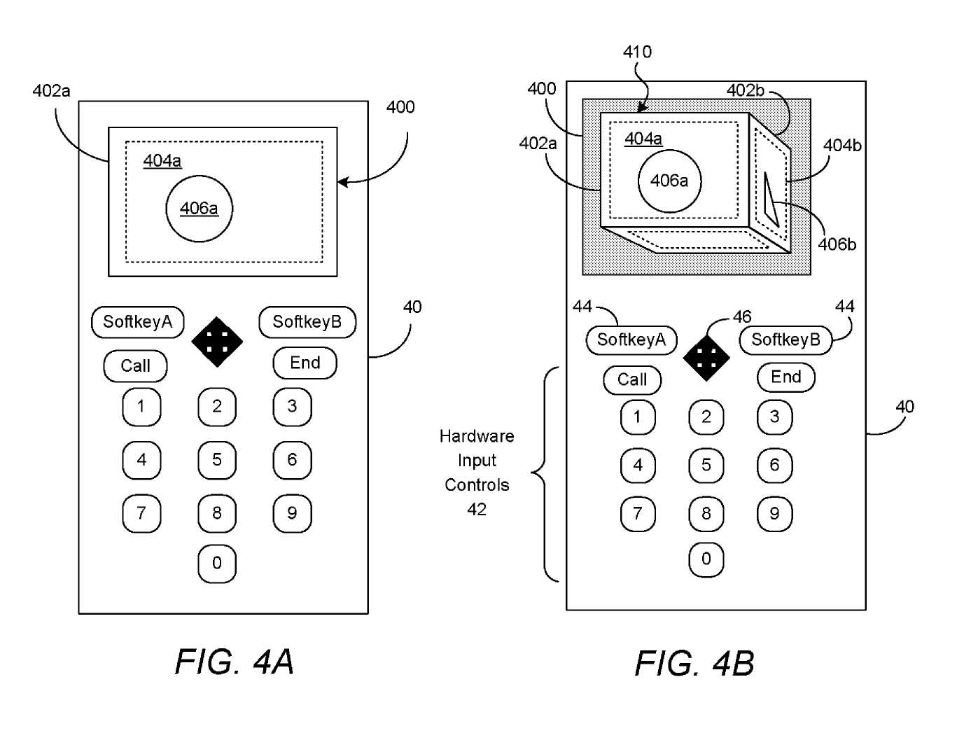

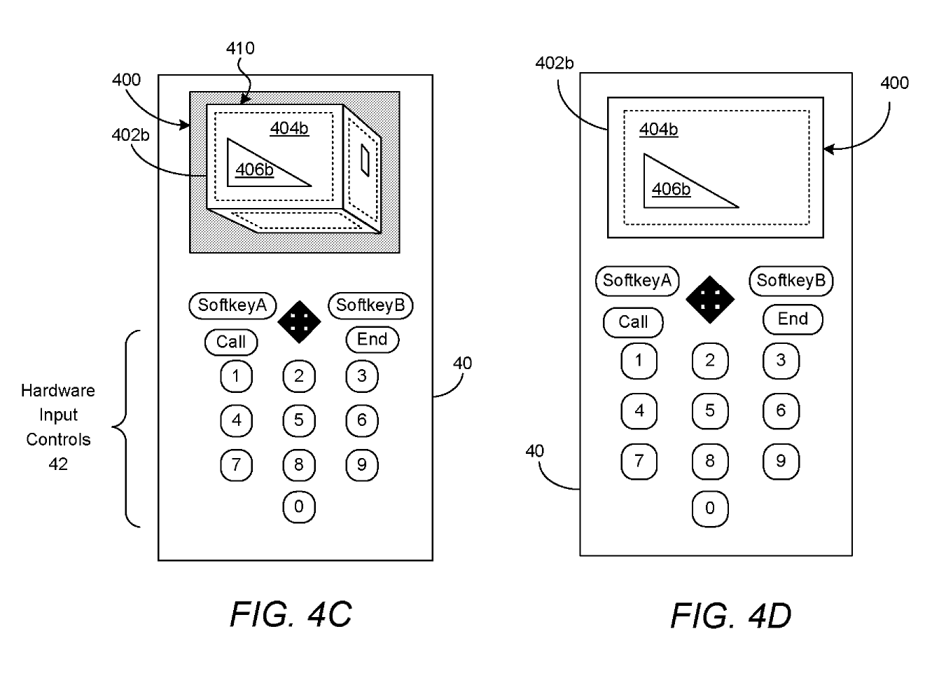

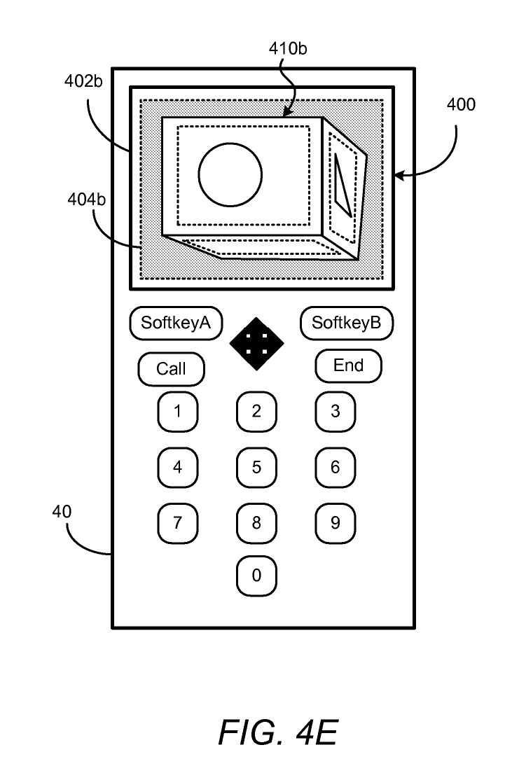

For example, in FIG. 4A an exemplary mobile device 40 includes a display 400 for presenting user interface widgets to the user. As is shown, the first side widget 402a having a first presentation space 404a is presented on the display 400 in full-screen mode. According to an exemplary embodiment, when the first side widget 402a is presented in full-screen mode, no other side widgets of the 3-D polyhedron are visible. Accordingly, the first side widget 402a is clearly displayed and the user can interact with the first side widget 402a with ease.

The first side widget 402a can be partially visible and the presentation space 404a can occupy a portion of the first side widget 402a, as shown in FIG. 4A, or the presentation space 404a can completely cover the first side widget 402a. According to an exemplary embodiment, the first presentation space 404a can include one or more application widgets 406a that represent one or more applications 110a, 110b and/or executable components operating in the execution environment 100. For example, in FIG. 1, a first application 110a can include a first application widget handler component 120a that is configured to generate a first application widget 406a to be presented in the first presentation space 404a. In FIG. 4A, the first presentation space 404a includes one application widget 406a. Nevertheless, in other embodiments, more than one application widget 406a can be presented in the presentation space 404a.

Referring again to FIG. 3, the exemplary method continues when, in response to receiving a first input, a 3-D polyhedron having a plurality of sides including a first side corresponding to the first side widget 402a and a selectable second side corresponding to a second side widget is presented on the display 400 (block 302). For example, in FIG. 4B, a visual representation of the 3-D polyhedron 410 showing the polyhedron's 3-D aspects is presented in the display 400. According to an exemplary embodiment, the 3-D polyhedron 410 can be associated with an application, a task, and/or a mode of the device or application. For example, when the device 40 is configured to operate in several different modes such as a camera mode and a phone mode, one side of the 3-D polyhedron can be associated applications or tasks related to the camera mode and another side of the 3-D polyhedron can be associated with applications or tasks related to the phone mode.

According to an exemplary embodiment, the device 40 includes means for presenting on the display 400, in response to receiving a first input, the 3-D polyhedron 410 having a first side corresponding to the first side widget 402a and a selectable second side corresponding to a second side widget 402b. For example, a ShowNormal component 212 (FIG. 2) in a polyhedron widget handler 210 can be configured to perform this function.

In one embodiment, the device 40 can be configured to receive a first input for indicating a normal-mode presentation of a 3-D polyhedron 410 on the display 400. In an exemplary embodiment, the first input can be received from a hardware input control 42, a softkey 44, a selection/navigation controller 46, and/or a pointing device (not shown) while the first side widget 402a is presented in full-screen mode. The first input, e.g., from the softkey 44, can be received by an input subsystem 160 (FIG. 1) included in the execution environment 100, and routed to an event router 158 included in the GUI manager 156. The event router 158 can interoperate with the GUI manager 156 to invoke the ShowNormal component 212 to present the corresponding 3-D polyhedron 410 showing the polyhedron's 3-D aspects.

In another embodiment, the display manager component 200 can include more than one instance of the polyhedron widget handler 210, such that, in response to the first input, more than one 3-D polyhedron 410 can be presented in the display 400. In this embodiment, the event router 158 interoperates with the GUI manager 156 to invoke the ShowNormal components 212 in the corresponding instances of the polyhedron widget handlers 210, each of which can instruct the GUI manager 156 to present the corresponding 3-D polyhedrons 410.

When invoked, the ShowNormal component 212 can notify the side widget handlers 220 corresponding to visible sides of the 3-D polyhedron 410 and instruct each side widget handler 220 to redraw or modify the presentation of the side widget, e.g., 402a, and its corresponding application widget 406a. For example, in FIG. 4B, the first and second side widgets 402a, 402b of the polyhedron 410 are visible. Accordingly, the side widget handlers 220a, 220b corresponding to the first and second side widgets 402a, 402b and the application widget handlers 120a, 120b corresponding to the first and second application widgets 406a, 406b can instruct the GUI manager 156 to draw visual representations of the first and second sides of the 3-D polyhedron 410 shown in FIG. 4B. In one embodiment, when the 3-D polyhedron 410 is presented, the first application widget 406a can be resized to occupy all of the presentation space 404a allowed by the side widget handler 220a.

Alternatively, rather than configuring the side widget handlers perform redraw operations to present a representation of the polyhedron; the shownNormal component 212 can be configured to present an image representing the polyhedron such as icon or a simple vector graphics (SVG) drawing. The image representation can be bitmapped for detecting inputs associated with the various visible sides depicted.

According to one embodiment, the device 40 can be configured to receive another input for indicating a rotation of the 3-D polyhedron 410 on the display 400. The input can be in response to a detected event, such as user input or a system or application generated event, and/or in response to an instruction from an execution environment component or from a client of the execution environment 100, such as an application 110a, 110b. For example, the rotation input can be received from a hardware input control 42, a softkey 44, a selection/navigation controller 46, and/or a pointing device (not shown) while the 3-D polyhedron 410 is presented showing the polyhedron's 3-D aspects. In one embodiment, when the rotation input is received, the 3-D polyhedron 410 can be rotated such that another side of the 3-D polyhedron 410, e.g., the second selectable side, is presented on the display 400 as a front side of the polyhedron 410. Here, the front side is that side of the polyhedron that is displayed as a plane closest, as among the sides of the polyhedron, to being parallel to a screen of the display 400.

In an alternative embodiment, the input for indicating a rotation can be received when the polyhedron 410 is presented on the display 400 for a predetermined period of time. For example, in response to a first input for indicating a normal-mode presentation of a 3-D polyhedron 410 on the display 400, the polyhedron 410 is presented on the display 400 as indicated. The input for indicating a rotation of the polyhedron 410 can be automatically received when no further input is received via the input subsystem 160 within the predetermined period of time. The rotation can be presented as smooth motion or can include one or more discreet stopping points.

When another rotation input is received, the 3-D polyhedron 410 can be rotated again such that yet another selectable side of the 3-D polyhedron 410 is presented on the display 400 as a front side of the polyhedron 410. In this manner, the various sides of the 3-D polyhedron 410 can be displayed so that the user can become familiar with the available applications and executable components.

Referring again to FIG. 3, the exemplary method continues when a second input associated with a selection of the selectable second side of the polyhedron is received (block 304). The second input can be in response to a detected event, such as user input or a system or application generated event, and/or in response to an instruction from an execution environment component or from a client of the execution environment 100, such as an application 110a, 110b. According to an exemplary embodiment, the device 40 includes means for receiving the second input associated with a selection of the selectable second side of the polyhedron 410. For example, the GUI manager component 156 in the GUI subsystem 150 can be configured to perform this function.

In one embodiment, the second input can be received when the selectable second side of the polyhedron is presented on the display 400 as the front side of the polyhedron 410 for a predetermined period of time. For example, in response to a rotation input, the 3-D polyhedron 410 can be rotated such that the second selectable side is presented on the display 400 as the front side of the polyhedron 410. If no further input is received within the predetermined period of time, the second input associated with the selection of the second side of the polyhedron 410 can be received.

According to another exemplary embodiment, the hardware input controls 42 of the device 40 can be associated with side widgets 402a, 402b of the polyhedron 410. For example, the “1” key included in the hardware input controls 42 can be associated with the first side widget 420a and the “2” key included in the hardware input controls 42 can be associated with the second side widget 402b. In this embodiment, the second input can be received in response to a user selection, such as a press and hold of the “2” key included in the hardware input controls 42. Because side widgets 402a, 402b are associated with designated keys 42, the side that is selected need not be visible on the display 400 when the second input is received. That is, the orientation and presentation mode of the 3-D polyhedron 410 is not necessarily relevant.

According to one embodiment, when the second input is received, the second side widget 402b including the second presentation space 404b is presented full-screen on the display 400 such that no other side of the polyhedron 410, including the first side, is visible when the second side widget 402b is presented full-screen on the display 400 (block 306). According to an exemplary embodiment, the device 40 includes means for presenting, in response to receiving the second input, full-screen on the display 400 of the device 40 the second side widget 402b that includes the second presentation space 404b. For example, the second side widget handler 220b, shown in FIG. 2, in the display manager component 200 can be configured to perform this function.

In one embodiment, when the second input is detected by the input subsystem 160, the event router 158 included in the GUI manager 156 is notified. The event router 158 interoperates with the GUI manager 156 to invoke the desktop manager component 200, which receives and processes the second input associated with the selection of the selectable second side of the polyhedron 410.

In one embodiment, when the desktop manager component 200 receives the second input, the second side of the polyhedron 410 can be identified and the second side widget handler 220b corresponding to the selected second side can be notified. When notified, the second side widget handler 220b can invoke a SetSideFocus component 224 that is configured to set the second side widget 402b as having input focus. In addition or alternatively, the SetSideFocus component 224 can determine whether the selected second side corresponding to the second side widget 402b is the front side, as defined above. When the selected second side is not the front side, the SetSideFocus component 224 can be configured to call the RotateFront component 214 to rotate the 3-D polyhedron 410 to a presentation position that presents the selected second side as the front side.

In one embodiment, the presentation of the rotating polyhedron 410 and the presentation of the selected second side as the front side can be performed by the SetSideFocus 224 and the RotateFront 214 components by calling the GUI subsystem 150 to present the 3-D polyhedron 410 in various rotational states. The GUI manager 156 can interoperate with other components of the GUI subsystem 150 for presenting the rotating polyhedron 410 and the front facing selected second side on the display 400, as shown in FIG. 4C.

According to an exemplary embodiment, once the SetSideFocus component 224 sets the second side widget 402b as having input focus, and the 3-D polyhedron 410 is optionally rotated so that the second side is presented as the front side, a ShowMaximized component 222 is invoked to present on the display 400 the second side widget 402b in full-screen mode, as depicted in the FIG. 4D. According to an exemplary embodiment, when the second side widget 402b is presented in full-screen mode, no other sides and side widgets of the 3-D polyhedron 410 are visible. Accordingly, the second side widget 402b is now clearly displayed and the user can interact with the second side widget 402b with ease.

As with the first side widget 402a, the second side widget 402b can be partially visible and the second presentation space 404b can occupy a portion of the second side widget 402b, as shown in FIG. 4C, or the second presentation space 404b can completely cover the second side widget 402b. According to an exemplary embodiment, the second presentation space 404a includes an application widget 406b that represents an application, e.g., 110b and/or executable component operating in the execution environment 100. For example, in FIG. 1, the second application 110b can include a second application widget handler component 120b that is configured to generate the second application widget 406b to be presented in the second presentation space 404b.

According to one embodiment, when the device 40 is configured to operate in a plurality of modes and the sides of the 3-D polyhedron 410 are associated with the operation modes of the device 40, the device can be automatically enabled to operate in the mode corresponding to the side that is presented full-screen on the display 400.

In another embodiment, the second application widget 406b can be a secondary 3-D polyhedron, and therefore, the second application widget handler component 120b can be a secondary polyhedron widget handler. The secondary polyhedron widget handler can include the ShowNormal 212 and RotateFront 214 components and the side widget handlers 220 so that the secondary 3-D polyhedron can present information in the same manner as the primary polyhedron. For example, as is shown in FIG. 4E, the secondary 3-D polyhedron 410b, can be presented in the presentation space 404b of the second side widget 402b showing the polyhedron's 3-D aspects in response to receiving a first input for indicating a normal-mode presentation of the secondary 3-D polyhedron 410b on the display 400. Furthermore, responsive to receiving a second input, the desktop manager component 200 can call the SetSideFocus component 224 of a selected side widget handler 220 operating in the context of the secondary polyhedron 410b, and present full-screen the selected side of the secondary 3-D polyhedron 410b in the presentation space 404b of the second side widget 402b.

Through aspects of the embodiments described, application widgets relating to a plurality of applications and other executable components are presented on at least two sides of a 3-D polyhedron. When a side of the 3-D polyhedron is selected, the side widget corresponding to the selected side can be automatically presented full-screen on the display such that all other sides of the polyhedron are not visible. Because no other sides of the 3-D polyhedron are presented, the user can easily see and interact with the application widget(s) in the presentation space of the side widget. It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for presenting information relating to a plurality of applications, the method comprising:
presenting full-screen on a display of an electronic device a first side widget that includes a first presentation space;
presenting on the display, in response to receiving a first input, a three-dimensional polyhedron having a plurality of sides including a first side corresponding to the first side widget and a selectable second side corresponding to a second side widget, wherein the second side widget includes a second presentation space;
receiving a second input associated with a selection of the selectable second side of the polyhedron; and
presenting, in response to receiving the second user input, full-screen on the display the second side widget that includes the second presentation space, wherein no other side of the polyhedron, including the first side, is visible when the second side widget is presented full-screen on the display and no other side of the polyhedron, including the second side, is visible when the first side widget is presented full-screen on the display.

2. The method of claim 1 wherein the electronic device is configured to operate in a plurality of device modes and the three-dimensional polyhedron widget comprises a plurality of sides corresponding to a plurality of side widgets and wherein the method further includes:
associating the plurality of device modes with the plurality of side widgets; and
automatically enabling the electronic device to operate in a device mode corresponding to a side widget when the side widget is presented full-screen on the display.

3. The method of claim 1 wherein the second presentation space displays a second three-dimensional polyhedron having a plurality of side widgets.

4. The method of claim 1 wherein prior to receiving the second input, the method includes receiving a third input associated with a command to rotate the three-dimensional polyhedron such that the second selectable side is presented on the display as a front side of the polyhedron, wherein the front side is that side of the polyhedron that is displayed as on a plane closest, as among the sides of the polyhedron, to being parallel to a screen of the display.

5. The method of claim 4 further comprising:
determining whether the second selectable side is the front side for a first predetermined period of time; and
automatically presenting the second side widget full-screen on the display based on the determination.

6. The method of claim 1 wherein the electronic device includes a plurality of input keys and wherein the method further includes:
associating a first of the plurality of input keys with the first side widget; and
associating a second of the plurality of input keys with the second side widget, wherein the second input comprises activating the second input key to select the second side of the polyhedron.

7. The method of claim 1 further including:
presenting on the display, in response to receiving the first input, a second three-dimensional polyhedron having a plurality of sides corresponding to a plurality of side widgets, wherein the second polyhedron is associated with at least one of an application, a task, and a mode of one of the device and the application.

8. A system for presenting information relating to a plurality of applications, the system comprising:
means for presenting full-screen on a display of an electronic device a first side widget that includes a first presentation space;
means for presenting on the display, in response to receiving a first input, a three dimensional representation of a polyhedron having a plurality of sides including a first side corresponding to the first side widget and a selectable second side corresponding to a second side widget;
means for receiving a second input associated with a selection of the selectable second side of the polyhedron; and
means for presenting, in response to receiving the second user input, full-screen on the display the second side widget that a second presentation space, wherein no other side of the polyhedron, including the first side, is visible when the second side widget is presented full-screen on the display, and no other side of the polyhedron, including the second side, is visible when the first side widget is presented full-screen on the display.

9. A system for presenting information relating to a plurality of applications available in an electronic device, the system comprising:
a display associated with an electronic device;
a graphical user interface manager component coupled to the display and configured for receiving inputs; and
a display manager component coupled to the graphical user interface manager, the display manager component configured for presenting full-screen on the display a first side widget that includes a first presentation space,
wherein the graphical user interface manager component and the display manager component are configured such that in response to the graphical user interface manager component receiving a first input, the display manager component presents on the display a three dimensional representation of a polyhedron having a plurality of sides including a first side corresponding to the first side widget and a selectable second side corresponding to a second side widget, and in response to the graphical user interface manager component receiving a second input associated with a selection of the selectable second side of the polyhedron, the display manager component presents full-screen on the display the second side widget that includes a second presentation space, wherein no other side of the polyhedron, including the first side, is visible when the second side widget is presented full-screen on the display, and no other side of the polyhedron, including the second side, is visible when the first side widget is presented full-screen on the display.

10. The system of claim 9 wherein the electronic device is configured to operate in a plurality of device modes and the three-dimensional polyhedron widget comprises a plurality of sides corresponding to a plurality of side widgets, and wherein the display manager component is configured for associating the plurality of device modes with the plurality of side widgets such that the electronic device is automatically enabled to operate in a device mode corresponding to a side widget when the side widget is presented full-screen on the display.

11. The system of claim 9 wherein the second presentation space displays a second three-dimensional polyhedron having a plurality of side widgets.

12. The system of claim 9 wherein the graphical user interface is configured for receiving a third input associated with a command to rotate the three-dimensional polyhedron such that the display manager component presents on the display the second selectable side as a front side of the polyhedron, wherein the front side is that side of the polyhedron that is displayed as on a plane closest, as among the sides of the polyhedron, to being parallel to a screen of the display.

13. The system of claim 12 wherein the display manager component is configured for determining whether the second selectable side is the front side for a first predetermined period of time and for automatically presenting the second side widget full-screen on the display based on the determination.

14. The system of claim 9 further comprising a plurality of input keys, wherein a first of the plurality of input keys is associated with the first side widget and a second of the plurality of input keys is associated with the second side widget, such that the second side of the polyhedron can be selected by activating the second input key.

15. The system of claim 9 wherein in response to the graphical user interface manager component receiving the first input, the display manager component is configured for presenting on the display a second three-dimensional polyhedron having a plurality of sides corresponding to a plurality of side widgets, wherein the second polyhedron is associated with at least one of an application, a task, and a mode of one of the device and the application.

16. A computer readable medium containing a computer program, executable by a machine, for presenting information relating to a plurality of applications, the computer program comprising executable instructions for:
presenting full-screen on a display of an electronic device a first side widget that includes a first presentation space;
presenting, in response to receiving a first input, on the display a three dimensional representation of a polyhedron having a plurality of sides including a first side corresponding to the first side widget and a selectable second side corresponding to a second side widget;
receiving a second input associated with a selection of the selectable second side of the polyhedron; and
presenting, in response to receiving the second user input, full-screen on the display the second side widget that includes a second presentation space, wherein no other side of the polyhedron, including the first side, is visible when the second side widget is presented full-screen on the display and no other side of the polyhedron, including the second side, is visible when the first side widget is presented full-screen on the display.
